(19) United States
(12) Patent Application Publication
(10) Pub. No.: US 2019/0053063 A1
(43) Pub. Date: Feb. 14, 2019

(54) METHOD, SYSTEM AND APPARATUS

(71) Applicant: NOKIA SOLUTIONS AND NETWORKS OY, Espoo (FI)

(72) Inventors: Christian Markwart, Munich (DE); Eva Perez, Munich (DE)

(21) Appl. No.: 16/088,806

(22) PCT Filed: Mar. 29, 2016
(86) PCT No.: PCT/EP2016/056747

§ 371 Date: Sep. 26, 2018

(51) Int. Cl. H04W 16/14; H04W 60/00; H04W 72/04; H04L 5/00; H04W 88/06; H04W 88/08

(52) U.S. Cl. CPC H04W 16/14; H04W 60/00; H04W 88/085; H04L 5/0055; H04W 88/06; H04W 72/0406

(57) ABSTRACT

There is provided a method comprising determining, at a first entity, whether to provide confirmation to a second entity in response to receiving and processing shared resource information from the second entity and, if so, determining how confirmation is provided to the second entity and providing control information from the first entity to the second entity, said control information comprising an indication of the determination.

### FIELD

The present application relates to a method, apparatus, system and computer program and in particular but not exclusively to a method for optimising dynamic network resource exchange between a network entity and a management entity.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). An example of attempts to solve the problems associated with the increased demands for capacity is an architecture that is known as the long-term evolution (LTE) of the Universal Mobile Telecommunications System (UMTS) radio-access technology. LTE is being standardized by the 3rd Generation Partnership Project (3GPP).

### SUMMARY

In a first aspect, there is provided a method comprising determining, at a first entity, whether to provide confirmation to a second entity in response to receiving and processing shared resource information from the second entity and, if so, determining how confirmation is provided to the second entity and providing control information from the first entity to the second entity, said control information comprising an indication of the determination.

Determining how confirmation is provided to the second entity may comprise determining whether the confirmation is provided in a dedicated confirmation message or a procedural network message.

The procedural network message may be one of a shared resource information request message and a shared resource notification acknowledgement message.

The method may comprise providing the control information in at least one of a request for registration with the second entity, a shared resource information request message and a shared resource information notification acknowledgement message.

The method may comprise determining whether to provide confirmation to the second entity based on a preconfiguration of at least one of the first and second entity.

Determining whether to provide confirmation to a second entity may comprise receiving further control information from the second entity, the further control information comprising an indication of whether the first entity is to send confirmation to the second entity in response to receiving and processing shared resource information from the second entity.

The method may comprise receiving the further control information in at least one of a response to a registration request, a response to a shared resource information request and a shared resource information notification message.

Determining whether to provide confirmation to a second entity may comprise providing further control information to the second entity, the further control information comprising an indication of whether the first entity prefers to send confirmation to the second entity in response to receiving and processing shared resource information from the second entity.

The method may comprise providing the further control information in at least one of a registration request, a shared resource information request message and a shared resource information notification acknowledgment message.

The first entity may be a network entity. The second entity may be a management entity.

In a second aspect, there is provided a method comprising receiving control information at a second entity from a first entity, said control information comprising an indication of a determination at the first entity to provide confirmation to a second entity in response to receiving and processing shared resource information from the second entity and how confirmation is provided to the second entity.

The indication may comprise an indication of whether the confirmation is provided in a dedicated confirmation message or a procedural network message.

The procedural network message may be one of a shared resource information request message and a shared resource information notification acknowledgement message.

The method may comprise receiving the control information in at least one of a request for registration with the second entity, a shared resource information request message and a shared resource information notification acknowledgment message.

The determination of whether to provide confirmation to a second entity may be based on a preconfiguration of at least one of the first and second entity.

The method may comprise providing further control information to the first entity, the further control information comprising an indication of whether the first entity is to send confirmation to the second entity in response to receiving and processing shared resource information from the second entity.

The method may comprise providing the further control information in at least one of a response to a registration request, a response to a shared resource information request message and a shared resource information notification message.

The method may comprise receiving further control information from the first entity, the further control information comprising an indication of whether the first entity prefers to send confirmation to the second entity in response to receiving and processing shared resource information from the second entity.

The method may comprise receiving the further control information in at least one of a registration request, a shared resource information request message and a shared resource information notification acknowledgement message.

The first entity may be a network entity. The second entity may be a management entity.

In a third aspect, there is provided an apparatus, said apparatus comprising means for determining, at a first entity, whether to provide confirmation to a second entity in response to receiving and processing shared resource information from the second entity, means for, if so, determining how confirmation is provided to the second entity and means for providing control information from the first entity to the second entity, said control information comprising an indication of the determination.

Means for determining how confirmation is provided to the second entity may comprise means for determining whether the confirmation is provided in a dedicated confirmation message or a procedural network message.

The procedural network message may be one of a shared resource information request message and a shared resource notification acknowledgement message.

The apparatus may comprise means for providing the control information in at least one of a request for registration with the second entity, a shared resource information request message and a shared resource information notification acknowledgement message.

The apparatus may comprise means for determining whether to provide confirmation to the second entity based on a preconfiguration of at least one of the first and second entity.

Means for determining whether to provide confirmation to a second entity may comprise means for receiving further control information from the second entity, the further control information comprising an indication of whether the first entity is to send confirmation to the second entity in response to receiving and processing shared resource information from the second entity.

The apparatus may comprise means for receiving the further control information in at least one of a response to a registration request, a response to a shared resource information request and a shared resource information notification message.

Means for determining whether to provide confirmation to a second entity may comprise means for providing further control information to the second entity, the further control information comprising an indication of whether the first entity prefers to send confirmation to the second entity in response to receiving and processing shared resource information from the second entity.

The apparatus may comprise means for providing the further control information in at least one of a registration request, a shared resource information request message and a shared resource information notification acknowledgment message.

The first entity may be a network entity. The second entity may be a management entity.

In a fourth aspect there is provided an apparatus comprising means for receiving control information at a second entity from a first entity, said control information comprising an indication of a determination at the first entity to provide confirmation to a second entity in response to receiving and processing shared resource information from the second entity and how confirmation is provided to the second entity.

The indication may comprise an indication of whether the confirmation is provided in a dedicated confirmation message or a procedural network message.

The procedural network message may be one of a shared resource information request message and a shared resource information notification acknowledgement message.

The apparatus may comprise means for receiving the control information in at least one of a request for registration with the second entity, a shared resource information request message and a shared resource information notification acknowledgment message.

The determination of whether to provide confirmation to a second entity may be based on a preconfiguration of at least one of the first and second entity.

The apparatus may comprise means for providing further control information to the first entity, the further control information comprising an indication of whether the first entity is to send confirmation to the second entity in response to receiving and processing shared resource information from the second entity.

The apparatus may comprise means for providing the further control information in at least one of a response to a registration request, a response to a shared resource information request message and a shared resource information notification message.

The apparatus may comprise means for receiving further control information from the first entity, the further control information comprising an indication of whether the first entity prefers to send confirmation to the second entity in response to receiving and processing shared resource information from the second entity.

The apparatus may comprise means for receiving the further control information in at least one of a registration request, a shared resource information request message and a shared resource information notification acknowledgement message.

The first entity may be a network entity. The second entity may be a management entity.

In a fifth aspect there is provided an apparatus comprising at least one processor and at least one memory including a computer program code, the at least one memory and the computer program code configured to, with the at least one processor, cause the apparatus at least to determine, at a first entity, whether to provide confirmation to a second entity in response to receiving and processing shared resource information from the second entity, if so, determine how confirmation is provided to the second entity and provide control information from the first entity to the second entity, said control information comprising an indication of the determination.

The apparatus may be configured to determine whether the confirmation is provided in a dedicated confirmation message or a procedural network message.

The procedural network message may be one of a shared resource information request message and a shared resource notification acknowledgement message.

The apparatus may be configured to provide the control information in at least one of a request for registration with the second entity, a shared resource information request message and a shared resource information notification acknowledgement message.

The apparatus may be configured to determine whether to provide confirmation to the second entity based on a preconfiguration of at least one of the first and second entity.

The apparatus may be configured to receive further control information from the second entity, the further control information comprising an indication of whether the first entity is to send confirmation to the second entity in response to receiving and processing shared resource information from the second entity.

The apparatus may be configured to receive the further control information in at least one of a response to a registration request, a response to a shared resource information request and a shared resource information notification message.

The apparatus may be configured to provide further control information to the second entity, the further control information comprising an indication of whether the first entity prefers to send confirmation to the second entity in response to receiving and processing shared resource information from the second entity.

The apparatus may be configured to provide the further control information in at least one of a registration request, a shared resource information request message and a shared resource information notification acknowledgment message.

The first entity may be a network entity. The second entity may be a management entity.

In a sixth aspect there is provided an apparatus comprising at least one processor and at least one memory including a computer program code, the at least one memory and the computer program code configured to, with the at least one processor, cause the apparatus at least to receive control information at a second entity from a first entity, said control information comprising an indication of a determination at the first entity to provide confirmation to a second entity in response to receiving and processing shared resource information from the second entity and how confirmation is provided to the second entity.

The indication may comprise an indication of whether the confirmation is provided in a dedicated confirmation message or a procedural network message.

The procedural network message may be one of a shared resource information request message and a shared resource information notification acknowledgement message.

The apparatus may be configured to receive the control information in at least one of a request for registration with the second entity, a shared resource information request message and a shared resource information notification acknowledgment message.

The determination of whether to provide confirmation to a second entity may be based on a preconfiguration of at least one of the first and second entity.

The apparatus may be configured to provide further control information to the first entity, the further control information comprising an indication of whether the first entity is to send confirmation to the second entity in response to receiving and processing shared resource information from the second entity.

The apparatus may be configured to provide the further control information in at least one of a response to a registration request, a response to a shared resource information request message and a shared resource information notification message.

The apparatus may be configured to receive further control information from the first entity, the further control information comprising an indication of whether the first entity prefers to send confirmation to the second entity in response to receiving and processing shared resource information from the second entity.

The apparatus may be configured to receive the further control information in at least one of a registration request, a shared resource information request message and a shared resource information notification acknowledgement message.

The first entity may be a network entity. The second entity may be a management entity.

In an seventh aspect there is provided a computer program embodied on a non-transitory computer-readable storage medium, the computer program comprising program code for controlling a process to execute a process, the process comprising determining, at a first entity, whether to provide confirmation to a second entity in response to receiving and processing shared resource information from the second entity and, if so, determining how confirmation is provided to the second entity and providing control information from the first entity to the second entity, said control information comprising an indication of the determination.

Determining how confirmation is provided to the second entity may comprise determining whether the confirmation is provided in a dedicated confirmation message or a procedural network message.

The procedural network message may be one of a shared resource information request message and a shared resource notification acknowledgement message.

The process may comprise providing the control information in at least one of a request for registration with the second entity, a shared resource information request message and a shared resource information notification acknowledgement message.

The process may comprise determining whether to provide confirmation to the second entity based on a preconfiguration of at least one of the first and second entity.

Determining whether to provide confirmation to a second entity may comprise receiving further control information from the second entity, the further control information comprising an indication of whether the first entity is to send confirmation to the second entity in response to receiving and processing shared resource information from the second entity.

The process may comprise receiving the further control information in at least one of a response to a registration request, a response to a shared resource information request and a shared resource information notification message.

Determining whether to provide confirmation to a second entity may comprise providing further control information to the second entity, the further control information comprising an indication of whether the first entity prefers to send confirmation to the second entity in response to receiving and processing shared resource information from the second entity.

The process may comprise providing the further control information in at least one of a registration request, a shared resource information request message and a shared resource information notification acknowledgment message.

The first entity may be a network entity. The second entity may be a management entity.

In an eighth aspect there is provided a computer program embodied on a non-transitory computer-readable storage medium, the computer program comprising program code for controlling a process to execute a process, the process comprising receiving control information at a second entity from a first entity, said control information comprising an indication of a determination at the first entity to provide confirmation to a second entity in response to receiving and processing shared resource information from the second entity and how confirmation is provided to the second entity.

The indication may comprise an indication of whether the confirmation is provided in a dedicated confirmation message or a procedural network message.

The procedural network message may be one of a shared resource information request message and a shared resource information notification acknowledgement message.

The process may comprise receiving the control information in at least one of a request for registration with the second entity, a shared resource information request message and a shared resource information notification acknowledgment message.

The determination of whether to provide confirmation to a second entity may be based on a preconfiguration of at least one of the first and second entity.

The process may comprise providing further control information to the first entity, the further control information comprising an indication of whether the first entity is to send confirmation to the second entity in response to receiving and processing shared resource information from the second entity.

The process may comprise providing the further control information in at least one of a response to a registration request, a response to a shared resource information request message and a shared resource information notification message.

The process may comprise receiving further control information from the first entity, the further control information comprising an indication of whether the first entity prefers to send confirmation to the second entity in response to receiving and processing shared resource information from the second entity.

The process may comprise receiving the further control information in at least one of a registration request, a shared resource information request message and a shared resource information notification acknowledgement message.

The first entity may be a network entity. The second entity may be a management entity.

In a ninth aspect there is provided a computer program product for a computer, comprising software code portions for performing the steps the method of the first and second aspect when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a schematic diagram of a network architecture in which embodiments may be performed;

FIG. 4 shows a flowchart of an example method for providing spectrum resource availability information (SRAI);

FIG. 5 shows a flowchart of an example method according to some embodiments;

FIG. 6 shows a flow chart of an example method for exchange of control information;

FIG. 7 shows two flow chart of two example methods for exchange of control information;

FIG. 8 shows a schematic diagram of a network architecture in which embodiments may be performed; FIG. 9 shows a flowchart of an example method of registration and SRAI information exchange in an LSA system;

FIG. 10 shows a schematic diagram of an example control apparatus.

### DESCRIPTION OF EMBODIMENTS

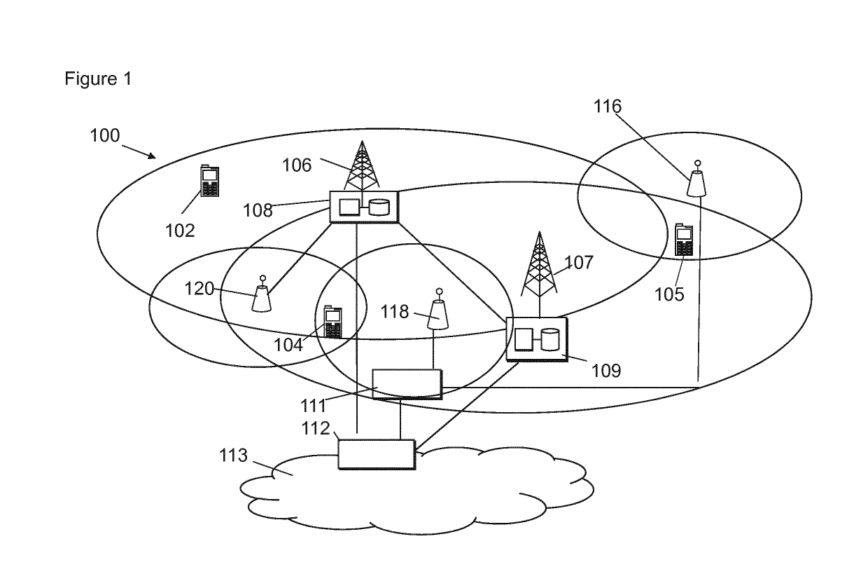

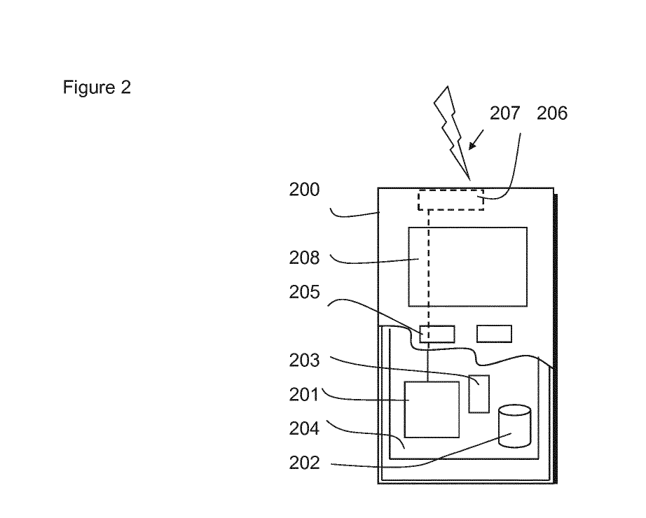

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. A base station is referred to as an eNodeB B (eNB) in LTE. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e) NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto. The communication devices 102, 104, 105 may access the communication system based on various access techniques.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Contrary to traditional exclusive spectrum assignment where spectrum resources may be exclusively assigned to a single operator, spectrum sharing is a method where spectrum resources may be jointly assigned to several operators with the obligation to use the spectrum resources collectively.

In addition to licensed and license-exempt (unlicensed) authorization methods, spectrum sharing concepts such as Licensed Shared Access (LSA), co-primary spectrum sharing, and multitier sharing via a Spectrum Access System (SAS) have been discussed to provide additional capacity to mobile networks. The following relates to radio access networks (RAN) comprising base stations (such as Macro, Pico and Femto base stations), which are enabled to use shared spectrum that is provided by an external management entity. Independent from the authorization method, improved spectrum management approaches may be desirable to meet the requirements on flexible spectrum.

LSA and multitier spectrum sharing are designed to support dynamic sharing options. While static sharing has no time dependencies and a Network Operator is allowed to use the spectrum in a similar fashion to dedicated licensed spectrum, dynamic sharing provides flexible controlling of shared spectrum resources via a management entity (e.g. LSA Repository or Spectrum Access System). Discussions as to how the management entity and the operator network exchange information on shared spectrum resources are ongoing.

LSA and multitier spectrum sharing are typical examples where an external management entity decides, based on defined sharing rules, which spectrum resource is provided to a requesting mobile network. The spectrum resource may be owned by an Incumbent (primary user), who allows other operators to use this spectrum resource for their purpose. Each spectrum resource is defined by a spectrum, a location where this spectrum is used, and a time frame when the spectrum is used.

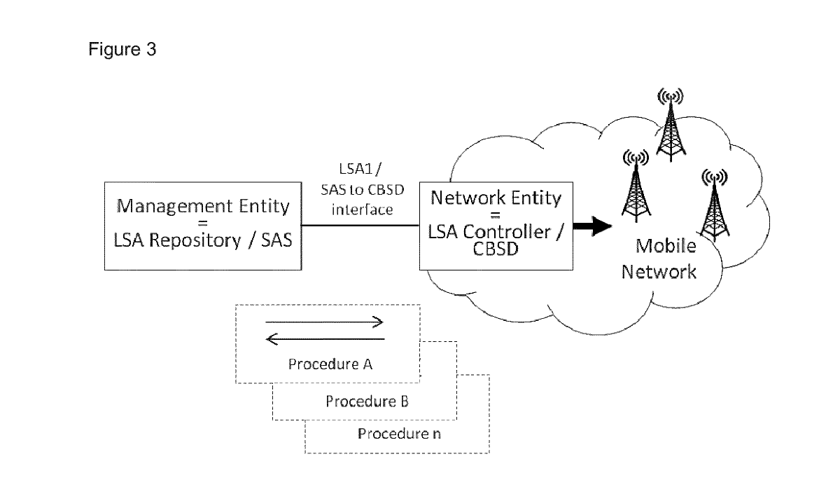

FIG. 3 shows an example system architecture which includes a management entity and a network entity. A set of procedures, A, B . . . n, for spectrum resource sharing have been defined to describe the general communication concept between the management entity and the network. FIG. 3 shows this principle for sharing methods for LSA and/or multitier sharing, where a LSA Repository/SAS represents the management entity and a LSA Controller/citizens broadband service device (CBSD), a network entity which provides the entry point for the mobile network.

The main task of the Network Entity may be to get availability information for the shared Spectrum Resource (SR) from the Management Entity and to provide this information to the mobile network. The availability information of a SR may be calculated at the Management Entity based on Incumbent inputs and a set of defined sharing rules. For example, LSA defines a general set of sharing rules, which are defined in the Sharing Framework issued by the national regulator and additional set of sharing rules, which are defined as Sharing Arrangement between Incumbent and LSA Licensee.

SR Availability Information (SRAI) allows the controlling of the SR usage in the mobile network. In dynamic sharing scenarios, the SRAI may change often. Based on the fact that the SRAI information needs to be consistent at the Management Entity and Network Entity, a two step mechanism may be used to synchronize the state between Management Entity (e.g. LSA Repository) and Network Entity (e.g. LSA Controller). In the first step the SRAI is received and processed at the Network Entity (LSA Controller). In the second step, when SRAI is executed in the network the Network Entity sends to the Management Entity a respective confirmation of the SRAI.

The SRAI may contain any information related to a spectrum resource SR and its availability for being used in an operator mobile fixed communications network (MFCN), such as but not limited to, the characteristics of a SR, partial or full set of parameters related to a SR or a Base Station BS that uses the SR, identity of a SR, constraints related to a SR (e.g. operational restrictions like power limitations, Exclusion Zones, Restriction Zones, and/or Protection Zones).

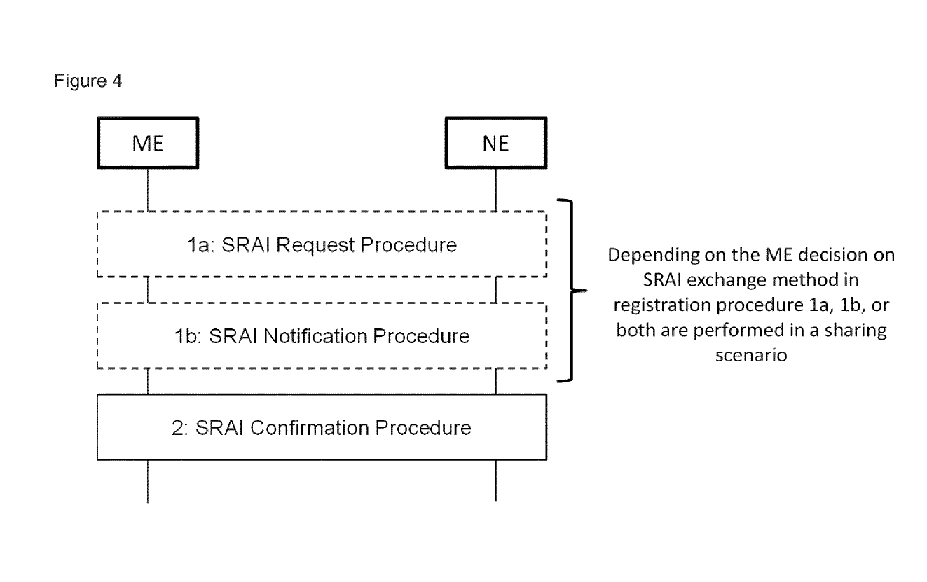

FIG. 4 shows an example 2 step procedure flow for LSA based Spectrum Resource Availability Information SRAI exchange between a ME and NE. In general there are 3 basic SRAI exchange methods possible. In the first method, referred to as method 1a, SRAI Request Procedure is initiated by the NE. Method 1a may be referred to as a “pull” procedure. In the second method, method 1b, SRAI Notification Procedure is initiated by the ME. Method 1b may be referred to as a “push” procedure. It may also be possible to allow both methods in parallel, i.e. both entities are allowed to initiate the SRAI exchange. Which SRAI exchange method is used in a specific sharing scenario is negotiated between ME and NE during a registration procedure, where the ME selects one of the two methods 1a, 1b, or both, for further operation. Common to all is that for synchronization reasons a second step, the confirmation procedure, is performed to confirm the execution of the exchanged SRAI information in the network.

An explicit SRAI confirmation message may introduce in several sharing scenarios an additional message exchange (such as Confirmation Request and Confirmation Response). For example, in some procedures, an exchange of SRAI involves at least four messages being exchanged between ME and NE. Such messages may increase interface capacity and/or load.

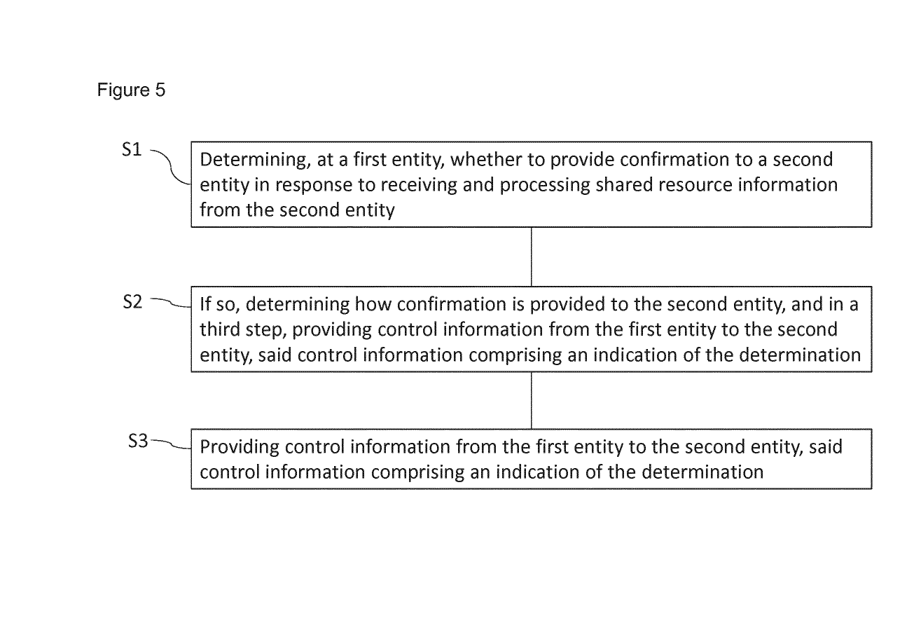

FIG. 5 shows a flowchart of an example method of exchanging SRAI control information between a management entity and a network entity. In a first step, the method comprises determining, at a first entity, whether to provide confirmation to a second entity in response to receiving and processing shared resource information from the second entity.

If so, in a second step, the method comprises determining how confirmation is provided to the second entity, and in a third step, providing control information from the first entity to the second entity, said control information comprising an indication of the determination.

The first entity may be a network entity, such as a LSA controller (LC) or a citizens broadband service device (CBSD). The second entity may be a management entity such as an LSA repository (LR) or SAS.

If confirmation is to be provided, the confirmation may be provided in a dedicated confirmation message, i.e. a confirmation procedure as discussed above, or a procedural network message, including but not limited to a subsequent SRAI request message and an SRAI notification acknowledgement (ACK). When confirmation is provided in a procedural network message, it may be provided as an information element in the procedural network message. The control information may comprise an indication that the confirmation is included in a dedicated confirmation messages or procedural network message.

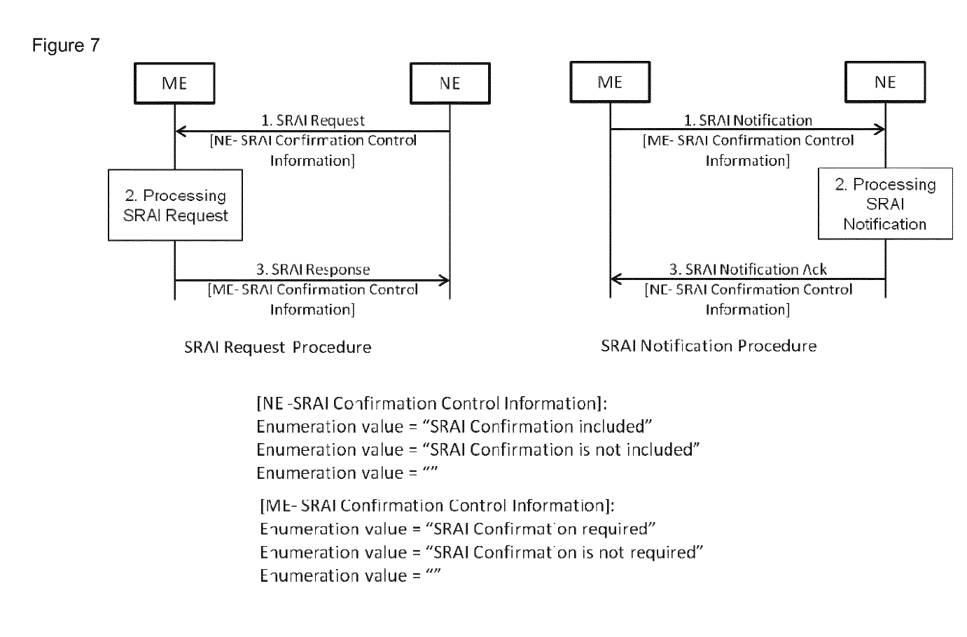

In push scenarios, e.g. method 1b described with reference to FIG. 4, the confirmation may be provided as an information element in a SRAI Notification ACK message. In push scenarios, e.g. method 1a as described with reference to FIG. 4, the confirmation may provided as an information element in a SRAI Request message subsequent to the receipt of the SRAI. SRAI Request and SRAI Notification ACK messages are illustrated in FIG. 7.

In pull scenarios (i.e. where an NE SRAI request and ME response mechanism is used) the LSA Repository has to guarantee that the LC will send a request regularly. This may be done by using a periodical request mechanism. The time interval may be either set via a parameter at the LC (configured or provided by LR in the protocol) or by limiting the usage of the spectrum resource in time (e.g. grant timer). In both cases, the LC can only use the spectrum resource continuously when the LR provides approval with the respective SRAI response. If the LR requires a confirmation the confirmation information is sent with the next SRAI request.

Whether to provide confirmation to a second entity in response to receiving and processing shared resource information from the second entity may be dependent on whether a second entity requires confirmation of the receiving and processing shared resource information by a first entity. The default for confirmation handling behaviour, i.e. whether confirmation is or is not to be provided in response to receiving and processing shared resource information from the second entity, may be defined for operation before operation phase starts. There may be two possibilities to provide the default behaviour. Either the default behaviour is configured at the ME and NE before operation starts and/or it is negotiated between ME and NE during registration. The negotiation may be performed using further control information exchanged between the first entity and the second entity. The default for Confirmation handling at ME and NE should be identical, before SRAI is exchanged.

The determining whether to provide confirmation to a second entity may be based on preconfigured information, e.g. the configuration at the ME and NE before operation. That is, the method may comprise determining whether to provide confirmation to the second entity based on a preconfiguration of at least one of the first and second entity. The preconfiguration may provide a default for the confirmation handing behaviour at the ME and/or the NE.

Alternatively, or in addition, the determining may comprise receiving further control information from the second entity, the further control information comprising an indication of whether the second entity requires confirmation from the first entity, that is whether the first entity is required to send confirmation to the second entity in response to receiving and processing shared resource information from the management entity and processing. In an embodiment, the further control information may be used to define if the ME requires an additional confirmation information or message to close a transaction, which is performed by a communication partner. The closing of the transaction may guarantee that the NE has processed a transferred information successfully.

The control information and further control information may be referred to as SRAI confirmation control information. The control information and/or further control information may be exchanged via an interface between a ME and a NE. SRAI confirmation control information may be sent from an ME to an NE and from an NE to an ME.

A method as described with reference to FIG. 5 may control whether or not a second confirmation step is performed without affecting the synchronization mechanism between the ME and NE. It may also allow both management and network entities to optimize the confirmation message exchange by allowing implicit confirmations when the sharing scenario requires the confirmation information.

The NE may provide confirmation, e.g. confirmation information, as a confirmation indicator, in a network procedural message, as opposed to a separate, dedicated, confirmation message. This may reduce the interface traffic. This mechanism may simplify the process of network resource sharing without reducing the robustness for information synchronization needs, especially in multi entity environments, e.g. multi MEs and/or multiple NEs.

Since the SRAI Confirmation Procedure is initiated by the NE, the control information, that is, SRAI confirmation control information sent by the NE, may distinguish between two situations when confirmation is required by the ME. The first situation is where Confirmation is included as an information element in a message, either along with the confirmation control information in, e.g. a SRAI notification acknowledgement message, or in a subsequent message such as an SRAI request message. The second situation is that confirmation is not included with the confirmation control information, and a confirmation is sent in separate message when required, e.g. a dedicated message in a confirmation procedure.

In general the ME and NE use the control information and further control information, i.e., SRAI confirmation control information, in two different situations, during registration of the NE with the ME and during operation, i.e. post registration, and before de-registration.

The negotiation may be performed as follows. In the registration phase, the NE registers with a Registration Request at the ME. The ME checks the request and answers with a Registration Response to inform the NE about the successful or non-successful registration depending whether or not the NE is qualified for spectrum sharing. During this registration procedure the ME may provide the SRAI confirmation control information in the Registration Response to inform the NE about the default handling of SRAI Confirmation in operation. The operation state is reached when the NE registration is finalized successfully and stays until de-registration or re-registration of the NE. In the case that the ME and/or NE doesn't provide the exchange of SRAI confirmation control information in the registration procedure, identical default Confirmation handling at the ME and NE before the start of the operation phase may be provided, for example, via configuration parameters or static implementation of the default behaviour in both entities.

In operation the NE may react according to the negotiation result. For example, if the NE receives from ME an indication that the SRAI Confirmation required, the NE operates as default in operation confirmations, i.e. the NE determines that confirmation is to be sent to the ME in response to receiving and processing the SRAI and provides confirmation in either a dedicated confirmation message or network procedural message. If the NE receives from ME an indication that SRAI Confirmation is not required the NE provides, as default, no confirmation in operation.

For flexible handling of the SRAI Confirmation control, the modification of the default confirmation handling behaviour during operation may be allowed. This may avoid a change requiring a de-registration and a re-registration with new negotiation of the default SRAI Confirmation handling. In this case, the method comprises receiving further control information from the second entity, and/or providing further control information to the second entity, said further control information comprising an indication of whether the first entity is to send confirmation in response to receiving and processing shared resource information from the second entity.

When the ME provides the further control information, the further control information may comprise one of “SRAI Confirmation required” and “SRAI Confirmation is not required”. When the NE provides the further control information, the further control information may comprise one of “SRAI confirmation required preferred” and “SRAI Confirmation is not required preferred”.

In operation the ME may use the “SRAI Confirmation required” and “SRAI Confirmation is not required” further control information to change the default SRAI Confirmation handling. The SRAI confirmation control information may be provided in operation as part of messages from ME to NE, i.e. SRAI Notification and SRAI Response messages. Table 1 provides an illustration of how an NE reacts based on the received SRAI confirmation control information.

If the ME omits the SRAI confirmation control information the NE follows the default behaviour.

### Table 1

The control information and further control information may be sent in a request from the first entity to the second entity, such as a registration request in the registration phase or an SRAI request in the operation phase, and/or in a notification acknowledgement message from the first entity to the second entity in the operation phase. Alternatively, or in addition, the further control information may be sent from the second entity to the first entity in a response such as a registration response in the registration phase or a SRAI response in the operation phase or an SRAI notification in the operation phase.

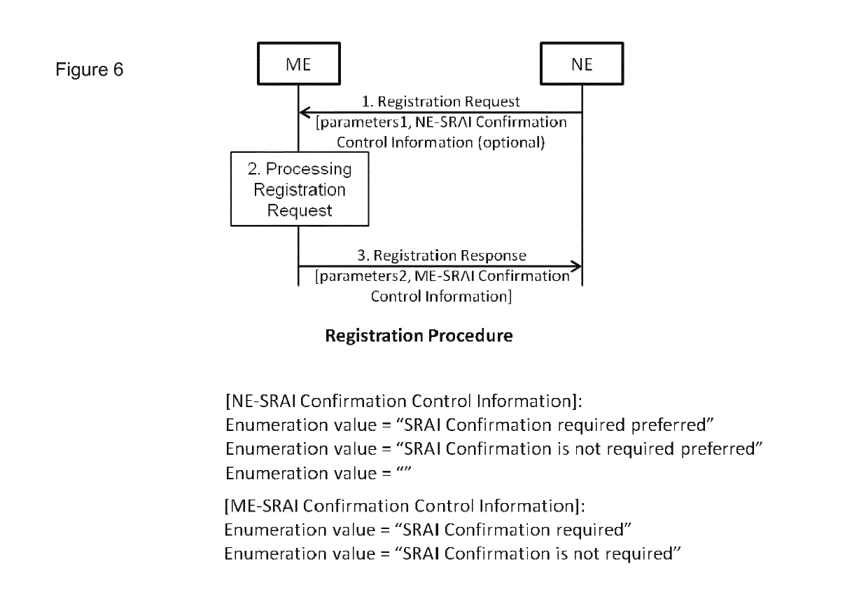

FIG. 6 shows how SRAI confirmation control information may be exchanged in the registration phase between an NE and ME in an embodiment. In the Registration Request from the NE, the SRAI confirmation control information is optional but may allow the Operator to inform the ME about the preferred default confirmation handling behaviour. If the ME receives the optional SRAI confirmation control information, the ME uses the further control information to decide whether the NE preferred default behaviour is accepted or overruled. The respective result on the chosen default Confirmation behaviour is then added as SRAI confirmation control information to the Registration Response message from the ME to the NE.

The registration procedure may be used by the NE to change from the registration phase to the operation phase, the SRAI Notification and SRAI Request procedure are used to exchange SRAI in the operation phase. The operation phase is stopped by the NE by initiating the de-registration procedure.

FIG. 7 shows an example of how SRAI confirmation control information is exchanged between ME and NE during an operation phase in an embodiment. In the first flow of FIG. 7, the NE initiates the SRAI Request procedure (a “pull” scenario) and in the second flow of FIG. 7, the ME initiates the SRAI Notification procedure (a “push” scenario).

In the operation phase, the ME may provide SRAI confirmation control information to inform the NE about a change of the SRAI Confirmation default handling, for example in SRAI response or SRAI notification. The NE may provide SRAI confirmation control information in an SRAI request or SRAI Notification ACK to inform the ME if the Confirmation is included in the message or subsequent network procedural message or will be sent in a dedicated message, e.g. SRAI Confirmation request.

When the NE provides SRAI confirmation control information in SRAI Response, the SRAI Confirmation may be provided in advance when used in the SRAI Confirmation Request. That is, in some cases (e.g. the spectrum resource is not used in the network or SRAI doesn't influence the spectrum resource usage), it is possible to send the confirmation in advance. The NE knows that confirmation is required and provides the confirmation in the SRAI request. When the ME receives such a SRAI request with a Confirmation in advance it provides the SRAI in the response and uses the confirmation which was received with the SRAI Request.

When the NE provides SRAI confirmation control information in SRAI Notification ACK message, the SRAI confirmation may be provided the confirmation is added to the SRAI ACK message, i.e. acknowledgement and confirmation is included in the same message.

SRAI Control information from the NE may be used in sharing scenarios where the NE pulls the SRAI by using the SRAI Request Procedure and the ME response includes a time value that defines how long the SR is available for usage in the network. When the time expires the NE has to stop the SR usage automatically or alternatively when the SR is still needed has to ask the ME in time to use the SR for another time period.

The SRAI confirmation control information may be extended to include an indication that the ME and/or NE is allowed to send multiple SRAI Information elements, e.g. NE is able to provide Confirmation included/not included and additional Confirmation required/not required preferred with the SRAI Request and/or SRAI Notification Acknowledgement message.

The SRAI confirmation control information may be extended to indicate whether or not SRAI Confirmation messages are required, i.e. the ME requires that the NE sends an SRAI Confirmation Request or not.

The SRAI confirmation control information may include an indication to allow in operation implicit Confirmation included/not included messages for multiple SRAI Requests and/or Notification Acknowledgements, e.g. a SRAI Request and or SRAI Notification Response may include a confirmation message for a previous SRAI Notification and/or SRAI Response from the ME.

The ME SRAI confirmation control information may include an indication to allow an ME in operation to temporarily overrule the default Confirmation behaviour for a defined number of messages, e.g. don't send a SRAI Confirmation for the provided SRAI even if the default Confirmation behaviour requires a Confirmation.

The SRAI confirmation control information may include additional parameters (e.g. time information) to allow scheduling of SRAI confirmation control information, e.g. the NE may provide SRAI Confirmation with a validity timer included as SRAI confirmation control information to the ME, i.e. even if the SRAI confirmation is included, the finalization of the SRAI related actions in the MFCN (Operator Network) cannot be guaranteed before the validity time is reached.

The SRAI confirmation control information may include a flexible combination of any of the above mentioned indications.

The SRAI confirmation control information, as described herein, may be included in Connectivity Check messages, e.g. Connectivity Check Request, Connectivity Check Response, Connectivity Notification, and Connectivity Notification Acknowledgement messages.

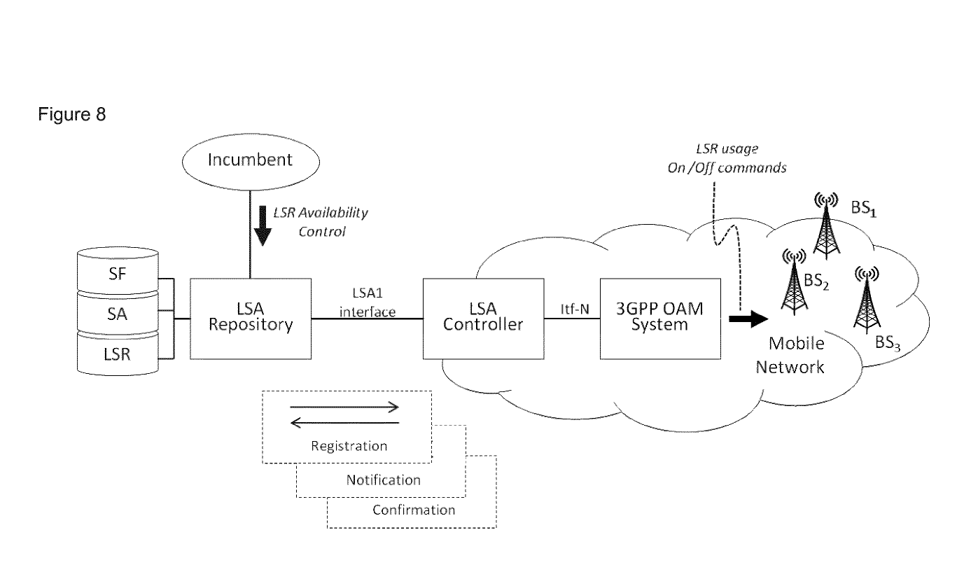

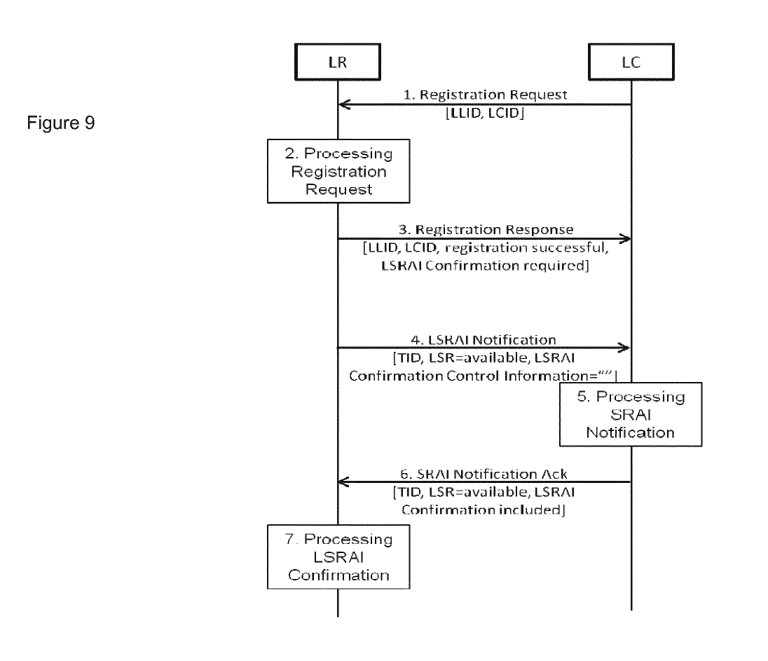

FIG. 8 shows an example system architecture in which a method may be implemented. The LSA Licensee has a LSA Controller LC installed in the Network that interacts with a 3GPP compliant OAM System and the LSA Repository LR. The LR is operated by a 3rd party and contains the management of the LSA Spectrum Resource LSR according to sharing rules defined in the Sharing Framework SF, set up by the NRA accompanied by a Sharing Arrangement SA between Incumbent and LSA Licensee. The Sharing rules allow the Incumbent to control the availability of the LSA Spectrum Resource LSR on short notice, i.e. the Incumbent is allowed to chance the LSRAI from available to not available and vice versa. Further the sharing scenario has specified to support the Confirmation exchange at the LSA1 interface and the exchange of LSRAI via the Notification procedure, i.e. LSRAI Request procedure is not used in this sharing scenario. The LC receives the

LSRAI from the LR and forwards it via the standardized northbound interface ltf-N to a 3GPP OAM system. The 3GPP OAM system will identify the respective Base Stations BS1-BS3 using the LSR and translates the LSRAI for the LSR into respective On or Off commands for the BSs.

FIG. 9 shows the respective set of parameters used at the LSA1 interface for an example sharing scenario. The LC provides a Registration Request to the LR. Once the LR processes the Registration Request, the LR provides a Registration Response to the LC, which includes LSA Licensee Identity (LLID), LSA controller identity (LCID), an indication that registration is successful and SRAI confirmation control information. In this example, the LSRAI confirmation is required. In step 4, the LR initiates the SRAI notification procedure. The LC processes the SRAI notification and provides control information to the LR. The control information provides an indication that LSRAI confirmation is included with the message. It may not be necessary to start, after step 6 a LSRAI Confirmation Procedure, because the Confirmation is already included as new parameter in the LSRAI Notification Acknowledgement, i.e. when the LR detects that the LSRAI Confirmation is included the LR can immediately start to process the LSRAI Confirmation.

It should be understood that each block of the flowchart of the Figures and any combination thereof may be implemented by various means or their combinations, such as hardware, software, firmware, one or more processors and/or circuitry.

It is noted that whilst embodiments have been described in relation to one example of a network and sharing spectrum example, similar principles may be applied in relation to other examples of e.g., 3G, LTE or 5G networks and spectrum sharing scenarios. It should be noted that other embodiments may be based on other cellular technology other than LTE or on variants of LTE. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

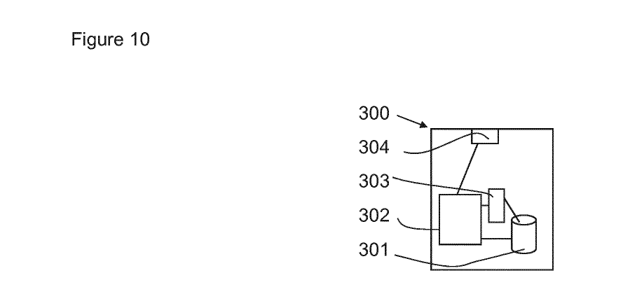

The method may be implemented in entities on a mobile device as described with respect to FIG. 2 or control apparatus as shown in FIG. 10. The method may be implanted in a single processor 201 or control apparatus or across more than one processor or control apparatus. FIG. 10 shows an example of a control apparatus for a communication system, for example to be coupled to and/or for controlling a station of an access system, such as a RAN node, e.g. a base station, (e) node B, a central unit of a cloud architecture or a node of a core network such as an MME or S-GW, a scheduling entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 or processor 201 can be configured to execute an appropriate software code to provide the control functions. Control functions may comprise determining, at a first entity, whether to provide confirmation to a second entity in response to receiving and processing shared resource information from the second entity; and, if so, determining how confirmation is provided to the second entity and providing control information from the first entity to the second entity, said control information comprising an indication of the determination.

Alternatively, or in addition, control functions may comprise receiving control information at a second entity from a first entity, said control information comprising an indication of a determination at the first entity to provide confirmation to a second entity in response to receiving and processing shared resource information from the second entity and how confirmation is provided to the second entity.

In an embodiment at least some of the functionalities of the apparatus of FIG. 10 may be shared between two physically separate devices forming one operational entity. Therefore, the apparatus may be seen to depict the operational entity comprising one or more physically separate devices for executing at least some of the described processes. The apparatus utilizing such shared architecture, may comprise a remote control unit (RCU), such as a host computer or a server computer, operatively coupled (e.g. via a wireless or wired network) to a remote radio head (RRH) located in the base station. In an embodiment, at least some of the described processes may be performed by the RCU. In an embodiment, the execution of at least some of the described processes may be shared among the RRH and the RCU.

In an embodiment, the RCU may generate a virtual network through which the RCU communicates with the RRH. In general, virtual net-working may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to the RCU). External network virtualization is targeted to optimized network sharing. Another category is internal virtual networking which provides net-work-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
determining, at a first entity, whether to provide confirmation to a second entity in response to receiving and processing shared resource information from the second entity; and, if so,
determining how confirmation is provided to the second entity; and
providing control information from the first entity to the second entity, said control information comprising an indication of the determination.

2. A method according to claim 1, wherein determining how confirmation is provided to the second entity comprises determining whether the confirmation is provided in a dedicated confirmation message or a procedural network message.

3. A method according to claim 2, wherein the procedural network message is one of a shared resource information request message and a shared resource notification acknowledgement message.

4. A method according to claim 1, comprising providing the control information in at least one of a request for registration with the second entity, a shared resource information request message and a shared resource information notification acknowledgement message.

5. A method according to claim 1, comprising determining whether to provide confirmation to the second entity based on a preconfiguration of at least one of the first and second entity.

6. A method according to claim 1, wherein determining whether to provide confirmation to a second entity comprises receiving further control information from the second entity, the further control information comprising an indication of whether the first entity is to send confirmation to the second entity in response to receiving and processing shared resource information from the second entity.

7. A method according to claim 6, comprising receiving the further control information in at least one of a response to a registration request, a response to a shared resource information request and a shared resource information notification message.

8. A method according to claim 1, wherein determining whether to provide confirmation to a second entity comprises providing further control information to the second entity, the further control information comprising an indication of whether the first entity prefers to send confirmation to the second entity in response to receiving and processing shared resource information from the second entity.

9. A method according to claim 8, comprising providing the further control information in at least one of a registration request, a shared resource information request message and a shared resource information notification acknowledgment message.

10. A method according to claim 1 wherein the first entity is a network entity and the second entity is a management entity.

11. A method comprising:
receiving control information at a second entity from a first entity, said control information comprising an indication of a determination at the first entity to provide confirmation to a second entity in response to receiving and processing shared resource information from the second entity and how confirmation is provided to the second entity.

12. A method according to claim 11, wherein the indication comprises an indication of whether the confirmation is provided in a dedicated confirmation message or a procedural network message.

13. A method according to claim 12, wherein the procedural network message is one of a shared resource information request message and a shared resource information notification acknowledgement message.

14. A method according to claim 11, comprising receiving the control information in at least one of a request for registration with the second entity, a shared resource information request message and a shared resource information notification acknowledgment message.

15. A method according to claim 11, wherein the determination of whether to provide confirmation to a second entity is based on a preconfiguration of at least one of the first and second entity.

16. A method according to claim 11, comprising providing further control information to the first entity, the further control information comprising an indication of whether the first entity is to send confirmation to the second entity in response to receiving and processing shared resource information from the second entity.

17. A method according to claim 15, comprising providing the further control information in at least one of a response to a registration request, a response to a shared resource information request message and a shared resource information notification message.

18. A method according to claim 11, comprising receiving further control information from the first entity, the further control information comprising an indication of whether the first entity prefers to send confirmation to the second entity in response to receiving and processing shared resource information from the second entity.

19. A method according to claim 18 comprising receiving the further control information in at least one of a registration request, a shared resource information request message and a shared resource information notification acknowledgement message.

20. A method according to claim 11, wherein the first entity is a network entity and the second entity is a management entity.

21-22. (canceled)

23. An apparatus comprising:
at least one processor and at least one memory including a computer program code, the at least one memory and the computer program code configured to, with the at least one processor, cause the apparatus at least to:
determine, at a first entity, whether to provide confirmation to a second entity in response to receiving and processing shared resource information from the second entity; and, if so,
determine how confirmation is provided to the second entity; and
provide control information from the first entity to the second entity, said control information comprising an indication of the determination.

24. An apparatus comprising:
at least one processor and at least one memory including a computer program code, the at least one memory and the computer program code configured to, with the at least one processor, cause the apparatus at least to:
receive control information at a second entity from a first entity, said control information comprising an indication of a determination at the first entity to provide confirmation to a second entity in response to receiving and processing shared resource information from the second entity and of how confirmation is provided to the second entity.
